(19) United States
(12) Patent Application Publication
(10) Pub. No.: US 2022/0198727 A1
(43) Pub. Date: Jun. 23, 2022

(54) Method and Apparatus For Hair Styling Analysis

(71) Applicants: Henkel AG & Co. KGaA, Duesseldorf (DE); Henkel IP & Holding GmbH, Duesseldorf (DE)

(72) Inventors: Behnam Khadem, Duesseldorf (DE); Jennifer S. Haghpanah, Stamford, CT (US)

(73) Assignees: Henkel AG & Co. KGaA, Duesseldorf (DE); Henkel IP & Holding GmbH, Duesseldorf (DE)

(21) Appl. No.: 17/247,721

(22) Filed: Dec. 21, 2020

(51) Int. Cl. G06T 11/60; G06K 9/00; G06Q 30/06; A45D 44/00

(52) U.S. Cl. CPC G06T 11/60; G06K 9/00281; G06K 9/00248; G06Q 30/0631; A45D 2044/007; A45D 44/005; G06T 2210/62; G06T 2200/24; G06Q 30/0643

(57) ABSTRACT

A method and apparatus for providing a hair style fullness indicator including capturing, by a camera, a first image of a subject having an initial hair style, determining, by a processor, an initial hair fullness of the initial hair style in response to an area of the initial hair style in the first image, capturing, by the camera, a second image of the subject having a subsequent hair style, determining, by the processor, a subsequent hair fullness of the subsequent hair style in response to an area of a subsequent hairstyle in the second image, and displaying, on a display, a hair fullness indicator in response to a ratio of the subsequent hair fullness to the initial hair fullness.

### FIELD OF THE INVENTION

Embodiments of the subject matter described herein relate generally to user interface design and configuration. More particularly, embodiments of the subject matter relate to capturing a before and after image of a hair styling process and providing user feedback on styling results, such as hair styling achievements.

### BACKGROUND OF THE INVENTION

When a user performs a hair styling operation or uses a hair styling product, the results are often difficult to ascertain as they involve a comparison to a hair state that no longer exits. For example, when a user uses a hair product, such as a conditioner, to increase hair fullness, the results should be compared to freshly washed hair without using the hair product. In this example, a prior instance of freshly washed hair may have occurred days earlier. In addition, comparing the results of two or more hair products or two hair styling techniques may occur over a longer time period making comparison difficult for a user.

People with certain disabilities may have difficulty evaluating the efficacy of a hair styling process or product. For example, a user with a visual impairment who desires to perform a hair straitening procedure may have difficulty determining when a desired level of hair straightening has been reached. The user will need an alternate feedback method for monitoring the progress of the hair straightening procedure. Likewise, people with visual impairments may have difficulty providing feedback to a hair stylist when a hair styling procedure is being performed on the user. Accordingly, it is desirable to overcome these problems and provide an improved method and apparatus for hair styling analysis. Furthermore, other desirable features and characteristics will become apparent from the subsequent detailed description and the appended claims, taken in conjunction with the accompanying drawings and the foregoing technical field and background.

### SUMMARY OF THE INVENTION

Disclosed herein are provision, control, and automation methods and systems and related control logic for configuring and provisioning user interfaces and for executing a system for hair styling analysis. By way of example, and not limitation, there is presented various embodiments of method and apparatus for image processing techniques for hair styling analysis are disclosed herein.

In accordance with an aspect of the present disclosure, a method including capturing, by a camera, a first image of a subject having an initial hair style, determining, by a processor, an initial hair fullness of the initial hair style in response to an area of the initial hair style in the first image, capturing, by the camera, a second image of the subject having a subsequent hair style, determining, by the processor, a subsequent hair fullness of the subsequent hair style in response to an area of a subsequent hairstyle in the second image, and displaying, on a display, a hair fullness indicator in response to a ratio of the subsequent hair fullness to the initial hair fullness

In accordance with another aspect of the present disclosure an apparatus for providing a hairstyle fullness indicator including a camera configured for capturing a first image of a subject having an initial hair style and a second image of the subject having a subsequent hair style, a processor configured for determining an initial hair fullness of the initial hair style in response to an area of the initial hair style in the first image, a subsequent hair fullness of the subsequent hair style in response to an area of a subsequent hairstyle in the second image and to generate the hairstyle fullness indicator in response to a ratio of the subsequent hair fullness to the initial hair fullness, and a display configured to display the hair fullness indicator to a user

In accordance with another aspect of the present disclosure, an apparatus for providing a hair style fullness indicator including a camera for capturing a first image of an initial hair style and a second image of a subsequent hair style, a processor configured for determining an initial fullness of the initial hair style in response to the first image and for determining a subsequent fullness of the subsequent hair style in response to the second image, and for generating a hair fullness indicator in response to a ratio of the subsequent fullness to the initial fullness, and a display configured for displaying the initial hair style, the subsequent hair style and the hair fullness indicator.

The above advantage and other advantages and features of the present disclosure will be apparent from the following detailed description of the preferred embodiments when taken in connection with the accompanying drawings.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an exemplary user interface for providing a hair styling analysis according to an exemplary embodiment of the present disclosure.

FIG. 2 is a block diagram of an exemplary system for providing a hair styling analysis according to an exemplary embodiment of the present disclosure.

FIG. 3 is a flowchart of a method for providing a hair styling analysis according to an exemplary embodiment of the present disclosure.

FIG. 4 is block diagram of another exemplary system for providing a hair styling analysis according to an exemplary embodiment of the present disclosure.

FIG. 5 is a flowchart of another method for providing a hair styling analysis according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION OF THE INVENTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of specific components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

System and methods are disclosed to measure the properties of a hair style through a photographic using two-dimensional image processing techniques. More specifically, the disclosed systems and methods calculate hair fullness gained or lost on a hair style within an image. This provides users the ability to evaluate hair styles based on a photo analysis of an image. This may also help the population of visually impaired people who cannot evaluate their hair style as well as providing customers means for evaluate hair styling products.

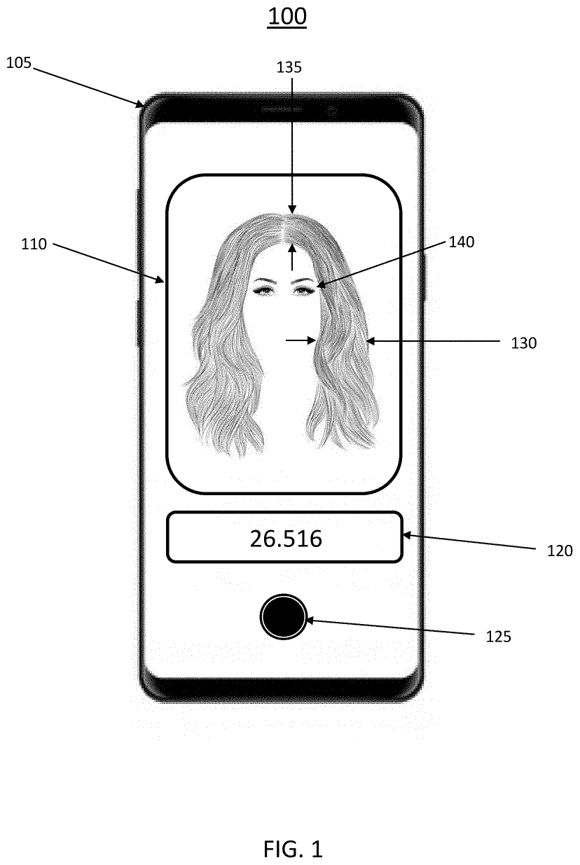

Turning now to FIG. 1, an exemplary user interface 100 for providing a hair styling analysis according to an exemplary embodiment of the present disclosure is shown. The exemplary user interface 100 may be deployed on a smartphone 105, or other user device, having a display and a camera. The user interface 100 may include an image 110 of the subject, a hair fullness/straigtening determination result 120 and an image capture button 125. The user interface 100 may perform an algorithm to prompt a user to capture a first “before” image of a hair style, a second “after” image of the hair style, and then provide a determined hair fullness result. In an alternative embodiment, the algorithm may prompt a user to select a previously captured “before” image and a previously captured “after” image from a camera photo gallery, photo directory, or the like on which the algorithm performs the hair fullness determination.

The user interface 100 allows a user to determine a hair style fullness result in response to at least one of a horizontal measurement 130 and a vertical measurement 135. In one exemplary embodiment, the horizontal or vertical measurement values may be referenced to a dimension of a facial feature such as a diameter of a pupil. This reference to a facial feature may be used to compensate for different distance between the camera and the subject from the different images used for comparison. The determination of dimensions, or relative dimensions of a specific object in an image allows for a determination of measurements within the image, such as the root lift, and left/right side hair fullness, curl fullness, and/or hair straightening.

In one exemplary embodiment, the algorithm performed by the user interface 100 may determine how far hair goes away from the face or scalp to quantify fullness of the hair style. Moreover, the way hair has expanded in length from inside to outside on a subject's head may be used to determine the fullness of the hair. When hair appears thicker/fuller in appearance through an image, it gives the feeling of volumized hair to the subject. Likewise, the algorithm could be used to quantify a straightening effect on curly hair. The lower the fullness, the more straight the hair would appear for a desire straight hair sleek look. The exemplary algorithm compares before and after image statistics and provides a value relative to hair style fullness which informs the user concerning their desired look.

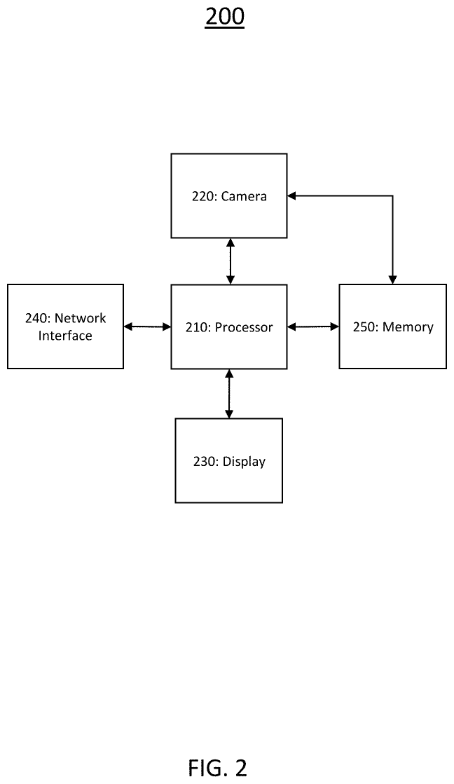

Turning now to FIG. 2, a functional block diagram of a system 200 for providing a hair styling analysis according to an exemplary embodiment of the present disclosure is shown. The exemplary system 200 may include a processor 210, a camera 220, a display 310, a memory 250, and a network interface 240. The system 200 may form a portion of a user device, such as a smartphone, personal computer, tablet computer or the like.

The camera 220 may be configured for capturing images. In one exemplary embodiment, the camera 220 is a digital camera employing a charge coupled device (CCD) sensor for capturing an electronic image of a field of view. The image may be captured in response to a user input, such as a button push on the user device, or may be captured in response to an instruction generated by the hair styling analysis algorithm. In performing the hair styling analysis algorithm, the camera 220 is operative to capture at least two images, a before image and an after image. The before image is captured before the hair styling procedure or before the hair styling product is applied. The after image is captured after the hair styling procedure is completed. The images may be stored on the memory 250, either by the camera directly or from the camera 220 to the memory 250 via the processor 210.

In this exemplary embodiment the processor 210 is configured to execute the hair styling analysis algorithm. The processor 210 receives the before image from the camera 220 or memory 250 and determines a hair fullness in response to receiving the image. In one exemplary embodiment, the hair fullness may be determined using a pixel density method. The pixel density method determines a number of pixels between a scalp line and an outer edge of the hair style or from a transition point between the face and hair and an outer edge of the hair style. The determined distance may be referenced to the number of pixels across an eye or a pupil. Alternatively, distances may be determined using a focal length method which uses the ratio between the focal length of the camera lens and the distance to the subject from the camera.

The estimated fullness of the before hair style may be determined in response to one or more of these radial measurements of the hair style. For example, three vertical measurements may be made, one aligned with the center of the face and one each at the outer edges, and six horizonal measurements, three on each side of the face with a first aligned at the top of the face, one at the bottom of the chin and one aligned with the top of the ear. The sum of multiple measurements may then be referenced to the width of the subject's pupil to generate an initial fullness factor. The initial fullness factor may then be stored in the memory 250.

The processor 210 is configured to repeat the fullness factor calculation on the after image to generate an after fullness factor. A ratio of the after fullness factor to the initial fullness factor greater than one indicates an increase in hair styling fullness. A ratio less than one indicates a flatter, less curly or frizzy, hair style. The processor 210 may then couple the ratio to the display 230 for presentation to the user. Alternatively, the ratio may be used to select an associated score or other user friendly description of the increase or decrease in fullness, such as “major fullness improvement” or “significantly increased straightness.” In one exemplary embodiment, the processor 210 may be configured for coupling the ratio to an information provider via the network interface 240. The processor 210 may then receive information from the information provider via the network interface 240 related to products or services which may improve fullness or straightness of a hair style associated with a user's styling goals. For example, the information provider may be a manufacturer of hair treatments and the data may be received from the information provider via a cellular network transmission channel and/or an internet connection.

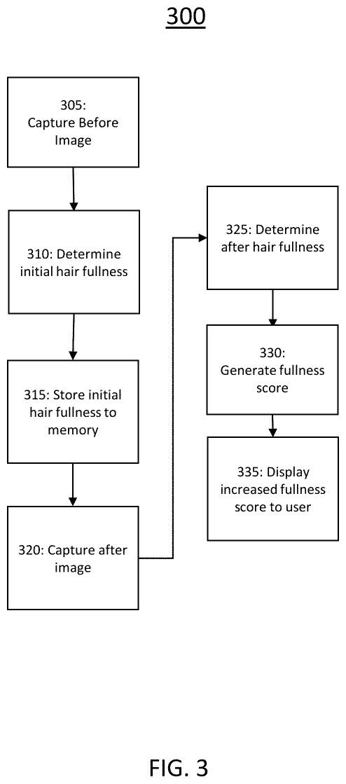

Turning now to FIG. 3, a flowchart of a method for providing a hair styling analysis according to an exemplary embodiment of the present disclosure is shown. The method is first operative to capture 305 a before image of the user's hair style. The before image may be captured by a digital camera integral to a user device in response to a prompt provide by the method and a user input. Alternatively, the image may be selected from a plurality of previously captured images stored on a memory within the user device.

The method is next operative to determine 310 an initial hair fullness in the initial image. In one exemplary embodiment, the initial hair fullness may be determined by determining an outline of the initial hair style within the image. The outline of the hair style may be detected in response to a change in color, luminosity, texture, or other image recognition technique. The number of pixels within the outline may then be referenced to a reference distance, such as the distance across a pupil of the subject, the width of the eye of the subject, length of the ear, or other biometric physical trait to generate an initial hair fullness score. The method then stores 315 this initial hair fullness score to a memory within the user device.

The method next captures 320 an after image of the user's hair style after a treatment has been applied or styling procedure has been performed. In some instances, the capture of the after image may be performed hours or days after the capture of the initial image. The method then determines 325 an after hair fullness in response to the after image. The hair fullness of the after image is determined in the same manner as the hair fullness of the initial image was determined, and is referenced to the same physical feature, such as pupil width. This referencing to a physical feature with a static dimension helps overcome changes is apparent hair fullness which may occur due to different subject distances. A subject distance is the distance between the camera and the subject for an image.

The method may then generate 330 a fullness score in response to a ratio of the after hair fullness and the initial hair fullness. In this example, a ratio greater than one is indicative of an increased fullness and a ratio less than one is indicative of a decreased fullness or an improved straightness. The method may then present 335 the ratio, or a factor or score derived from the ratio, to the user

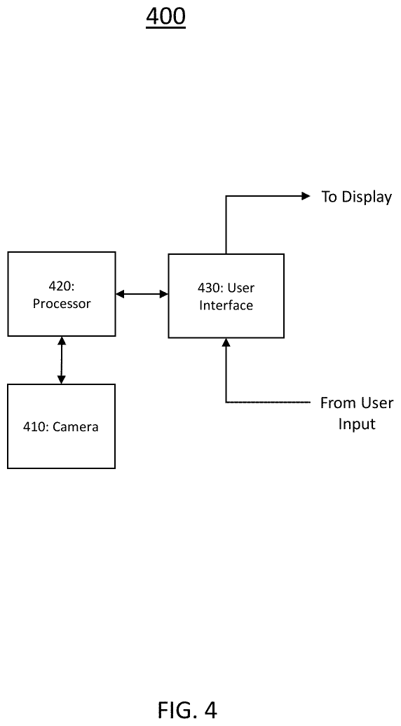

Turning now to FIG. 4, a block diagram illustrating a system 400 for providing a hairstyle fullness indicator according to an exemplary embodiment of the present disclosure is shown. The exemplary system 400 may include a camera 410, a processor 420, and a user interface 430. The exemplary system 400 may form a portion of a mobile computing device, a smartphone, cellular phone, tablet computer, or personal computer.

The exemplary system 400 may include a camera 410 configured for capturing a first image of a subject having an initial hair style and a second image of the subject having a subsequent hair style. The camera may be integral to the system, such as a mobile phone camera, or may be a peripheral device, such as a webcam employed with a personal computer. Alternatively, the camera may be an electronic storage device for storing images, such as a computer hard driver or universal serial bus thumb drive, where a plurality of images is stored on the storage device.

The processor 420 may be configured for determining an initial hair fullness of the initial hair style in response to an area of the initial hair style in the first image, a subsequent hair fullness of the subsequent hair style in response to an area of a subsequent hairstyle in the second image and to generate the hairstyle fullness indicator in response to a ratio of the subsequent hair fullness to the initial hair fullness. The processor may receive the images in response to providing a user prompt, a user action at the user interface 430, such as a button push, and receiving the image from the camera 410. Alternatively, the processor 420 may provide a user prompt and facilitate a user selecting one or more images from a plurality of images. For example, a user may select an initial image and a subsequent image from a photo gallery application of prior. The processor 420 may then use these images as the first image and the second image.

In one exemplary embodiment, the processor 420 may determine the initial hair fullness includes determining a first distance between an outer edge of the initial hair style and an edge of a face of the subject in the first image and where determining the subsequent hair fullness includes determining a second distance between an outer edge of the initial hair style and an edge of a face of the subject in the second image. Alternatively, the processor 420 may determine the initial hair fullness in response to a first number of pixels displaying the initial hair style and wherein the subsequent hair fullness in response to a second number of pixels displaying the subsequent hair style.

The user interface may be configured to display, using a display device, the hair fullness indicator to a user and to receive a user command via a user input. In one example, the user interface may display a semitransparent version of the first image over the second image. Thus the user may observe the changes in fullness along with the hair fullness indicator. The images may be aligned by aligning common static features in the images, such as eyes, mouth, nose and the like. The user interface 430 may also be configured for providing a plurality of plurality of hair fullness goals on a display, receiving a desired hair fullness goal from the user and recommending a hair product in response to the hair fullness goal and the ratio. The hair product recommendation may be stored on a memory within the system and selected in response to the hair fullness goal and the ratio. Alternatively, the system 400 may transmit the hair fullness goal and the ratio to a service provider, such as a network server, and receive a hair product recommendation from the service provider in response to the transmitted information.

In order to calibrate the initial hair fullness with the subsequent hair fullness between the first image and the second image and to compensate for different distances between the camera and the subject, the initial hair fullness may be scaled and the subsequent hair fullness may scaled in response to a fixed biometric indicator, such as a subject's pupil size depicted in the images.

The determined ratio may be used to provide an indication of an increase or decrease in hairy style fullness. For example, the ratio of the subsequent hair fullness to the initial hair fullness is indicative of an increase in hair style fullness in response to the ratio being greater than one and wherein the indicator is displayed as an increase in the hair fullness indicator. Likewise, the ratio of the subsequent hair fullness to the initial hair fullness is indicative of an increase in hair style straightness in response to the ratio being less than one and wherein the indicator is displayed as a decrease in the hair fullness indicator.

In one exemplary embodiment, the system 400 is an apparatus for providing a hair style fullness indicator including a camera for capturing a first image of an initial hair style and a second image of a subsequent hair style, a processor configured for determining an initial fullness of the initial hair style in response to the first image and for determining a subsequent fullness of the subsequent hair style in response to the second image, and for generating a hair fullness indicator in response to a ratio of the subsequent fullness to the initial fullness, and a display configured for displaying the initial hair style, the subsequent hair style and the hair fullness indicator. This apparatus may further included a user interface for receiving a hair fullness goal from a user and a network interface for transmitting, to a service provider, the hair fullness goal and the ratio of the subsequent fullness to the initial fullness and for receiving, from the service provider, a hair product recommendation where the display is further operative to display the hair product recommendation.

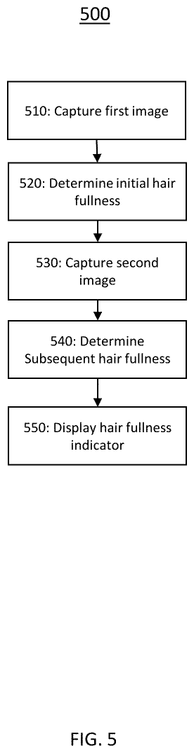

Turning now to FIG. 5, a flowchart illustrating a method 500 for bypass block webpage navigation according to an exemplary embodiment of the present disclosure is shown. In this exemplary method 500, the user device may be a smartphone running a software application.

The method is first operative for capturing 510 a first image of a subject having an initial hair style. The first image may be captured by a camera or may be selected from a plurality of images stored in a memory. The method next may using image processing techniques for determining 520 an initial hair fullness of the initial hair style in response to an area of the initial hair style in the first image. In one example, determining the initial hair fullness includes determining a first distance between an outer edge of the initial hair style and an edge of a face of the subject in the first image. Alternatively, the initial hair fullness may be determined in response to a first number of pixels displaying the initial hair style. For example, the area of the initial hair style, represented in pixels, in the two-dimensional image.

The method is next operative for capturing 530, by a camera or by selection from a plurality of images, a second image of the subject having a subsequent hair style. The method then determines 540 , by a processor or the like, a subsequent hair fullness of the subsequent hair style in response to an area of a subsequent hairstyle in the second image. Determining the subsequent hair fullness may include determining a second distance between an outer edge of the initial hair style and an edge of a face of the subject in the second image. The subsequent hair fullness may alternatively be determined in response to a second number of pixels displaying the subsequent hair style. In one embodiment, the initial hair fullness is scaled in response to a subject's pupil size depicted in the first image and the subsequent hair fullness is scaled in response to a subject's pupil size or eye size depicted in the second image.

The method is next configured for displaying 550, on a display or user interface, a hair fullness indicator in response to a ratio of the subsequent hair fullness to the initial hair fullness. The hair fullness indicator may be indicative of an increase in hair style fullness in response to the ratio being greater than one and wherein the indicator is displayed as an increase in the hair fullness indicator. The hair fullness indicator may also be indicative of an increase in hair style straightness in response to the ratio being less than one and wherein the indicator is displayed as an increase in hair straightness. In one embodiment, the method may further display displaying a semitransparent version of the first image over the second image on the display such that the user may be provided a comparison of the subsequent to initial hair style fullness as well as the hair fullness indicator.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The various tasks performed in connection with the process may be performed by software, hardware, firmware, or any combination thereof. For illustrative purposes, the following description of process may refer to elements mentioned above. In practice, portions of process may be performed by different elements of the described system, e.g., component A, component B, or component C. It should be appreciated that process may include any number of additional or alternative tasks, the tasks shown need not be performed in the illustrated order, and process may be incorporated into a more comprehensive procedure or process having additional functionality not described in detail herein. Moreover, one or more of the tasks shown could be omitted from an embodiment of the process as long as the intended overall functionality remains intact.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method comprising:
capturing, by a camera, a first image of a subject having an initial hair style;
determining, by a processor, an initial hair fullness of the initial hair style in response to an area of the initial hair style in the first image;
capturing, by the camera, a second image of the subject having a subsequent hair style;
determining, by the processor, a subsequent hair fullness of the subsequent hair style in response to an area of a subsequent hairstyle in the second image; and
displaying, on a display, a hair fullness indicator in response to a ratio of the subsequent hair fullness to the initial hair fullness.

2. The method of claim 1, wherein determining the initial hair fullness includes determining a first distance between an outer edge of the initial hair style and an edge of a face of the subject in the first image and where determining the subsequent hair fullness includes determining a second distance between an outer edge of the initial hair style and an edge of a face of the subject in the second image.

3. The method of claim 1, wherein the initial hair fullness is determined in response to a first number of pixels displaying the initial hair style and wherein the subsequent hair fullness is determined in response to a second number of pixels displaying the subsequent hair style.

4. The method of claim 1, wherein the hair fullness indicator is indicative of an increase in hair style fullness in response to the ratio being greater than one and wherein the indicator is displayed as an increase in the hair fullness indicator.

5. The method of claim 1, wherein the hair fullness indicator is indicative of an increase in hair style straightness in response to the ratio being less than one and wherein the indicator is displayed as an increase in hair straightness.

6. The method of claim 1 further including receiving a desired hair fullness goal from the user and recommending a hair product in response to the hair fullness goal and the ratio.

7. The method of claim 1 wherein the user device is a smartphone.

8. The method of claim 1 including displaying a semitransparent version of the first image over the second image.

9. The method of claim 1 wherein the initial hair fullness is scaled in response to a subject's pupil size depicted in the first image and the subsequent hair fullness is scaled in response to a subject's pupil size depicted in the second image.

10. An apparatus for providing a hairstyle fullness indicator comprising:
a camera configured for capturing a first image of a subject having an initial hair style and a second image of the subject having a subsequent hair style;
a processor configured for determining an initial hair fullness of the initial hair style in response to an area of the initial hair style in the first image, a subsequent hair fullness of the subsequent hair style in response to an area of a subsequent hairstyle in the second image and to generate the hairstyle fullness indicator in response to a ratio of the subsequent hair fullness to the initial hair fullness; and
a user interface configured to display the hair fullness indicator to a user.

11. The apparatus for providing a hairstyle fullness indicator of claim 10, wherein determining the initial hair fullness includes determining a first distance between an outer edge of the initial hair style and an edge of a face of the subject in the first image and where determining the subsequent hair fullness includes determining a second distance between an outer edge of the initial hair style and an edge of a face of the subject in the second image.

12. The apparatus for providing a hairstyle fullness indicator of claim 10, wherein the initial hair fullness is determined in response to a first number of pixels displaying the initial hair style and wherein the subsequent hair fullness is determined in response to a second number of pixels displaying the subsequent hair style.

13. The apparatus for providing a hairstyle fullness indicator of claim 10, wherein the ratio of the subsequent hair fullness to the initial hair fullness is indicative of an increase in hair style fullness in response to the ratio being greater than one and wherein the indicator is displayed as an increase in the hair fullness indicator.

14. The apparatus for providing a hairstyle fullness indicator of claim 10, wherein the ratio of the subsequent hair fullness to the initial hair fullness is indicative of an increase in hair style straightness in response to the ratio being less than one and wherein the indicator is displayed as a decrease in the hair fullness indicator.

15. The apparatus for providing a hairstyle fullness indicator of claim 10, further including receiving, via the user interface, a desired hair fullness goal from the user and recommending a hair product in response to the hair fullness goal and the ratio.

16. The apparatus for providing a hairstyle fullness indicator of claim 10, wherein the user interface is further configured for displaying a semitransparent version of the first image over the second image.

17. The apparatus for providing a hairstyle fullness indicator of claim 10, wherein the processor is further configured to provide a prompt to the user to select the first image and the second image from a plurality of images stored in a memory.

18. The apparatus for providing a hairstyle fullness indicator of claim 10, wherein the initial hair fullness is scaled in response to a subject's pupil size depicted in the first image and the subsequent hair fullness is scaled in response to a subject's pupil size depicted in the second image.

19. An apparatus for providing a hair style fullness indicator comprising:
a camera for capturing a first image of an initial hair style and a second image of a subsequent hair style;
a processor configured for determining an initial fullness of the initial hair style in response to the first image and for determining a subsequent fullness of the subsequent hair style in response to the second image, and for generating a hair fullness indicator in response to a ratio of the subsequent fullness to the initial fullness; and
a display configured for displaying the initial hair style, the subsequent hair style and the hair fullness indicator.

20. The apparatus for providing a hair style fullness indicator of claim 19 further comprising:
a user interface for receiving a hair fullness goal from a user;
a network interface for transmitting, to a service provider, the hair fullness goal and the ratio of the subsequent fullness to the initial fullness and for receiving, from the service provider, a hair product recommendation; and
the display being further operative to display the hair product recommendation.
